(19) United States
(12) Patent Application Publication
(10) Pub. No.: US 2006/0182124 A1
(43) Pub. Date: Aug. 17, 2006

(54) Cipher Key Exchange Methodology

(75) Inventors: Eric B. Cole, Leesburg, VA (US); James W. Conley, Herndon, VA (US)

Correspondence Address: MARTIN & HENSON, P.C., 9250 W 5TH AVENUE, SUITE 200, LAKEWOOD, CO, 80226, US

(73) Assignee: SYTEX, INC., Doylestown, PA (US)

(21) Appl. No.: 10/906,330

(22) Filed: Feb. 15, 2005

(51) Int. Cl. H04L 12/28; H04L 12/56

(52) U.S. Cl. 370/395.54; 370/400

(57) ABSTRACT

Methods are provided relating to the exchange of a cipher key between devices on a network segment to enable encrypted transmissions between the devices. In preferred embodiments the cipher key is a random key which is commonly used by the devices for synchronous encryption/decryption of data.

### BACKGROUND OF THE INVENTION

The present invention broadly concerns communications among devices along a network segment. More particularly, the invention concerns the exchange of a cipher key between devices (or hosts) on a Ethernet network segment to enable subsequent, secure transmissions between the devices in accordance with a symmetric cryptographic scheme.

Each device connected to an Ethernet network has two addresses, a medium access control (MAC) address and an Internet Protocol (IP) address. Information is currently routed over the internet by using a 4-byte IP address. However, packets are routed on each segment by a hardware address and, in the case of the Ethernet, this hardware address is a 6-byte MAC address built into each network interface. An IP address is used to determine the route, and a MAC address is used to send the packet to the next hop. Thus, a host on a Ethernet network can communicate with another host only if it knows the Ethernet address (MAC address) of that host. This relationship is diagrammatically depicted in FIG. 1 which shows a logical communication link 1 between a sending host and a target host by virtue of their IP addresses, while the packets themselves physically travel along network segments 2-4, such as through routers 5 & 6, from device to device.

The address resolution protocol (ARP) is a general protocol which can be used on various types of broadcast networks, and the protocol is defined by the Internet Engineering Task Force (IETF) at RFC 826. It is predominately used with IEEE 802.X compliant LAN architectures, including the Ethernet, fiber-distributed-data-interface (FDDI), frame relay, token ring, and other environments. The protocol details differ for each type of LAN, and there are separate ARP specifications for each. Where IPv4 is concerned, ARP operates as an interface between the network layer (layer 3) and the data link layer (layer 2) of the OSI model to perform mapping of an IP address to a hardware address that is recognized in the local network. In IPv4, the addresses are 32 bits long, while the hardware addresses for the devices are 48 bits. A table, typically referred to as an ARP cache is used to maintain the correlation between each Ethernet MAC address and its associated IP address. Entries in the ARP cache are added and removed dynamically.

The conversion from IP to hardware address, for each segment crossed, is accomplished with a series of ARP requests. Thus, when ARP needs to resolve a given IP address to an Ethernet MAC address, it broadcasts a packet within a broadcast domain to any network interface card (NIC) connected to the network segment which is listening. The network segment may be considered as that portion of the network which is bounded by bridges, routers, repeaters or terminators. An ARP request essentially asks “Who should I send my packets to for IP address xx.xx.xx.xx?” When the ARP request is broadcast, it is received and processed by all hosts in the network. If the IP address to be resolved does not correspond to the Ethernet MAC address of the receiving host, then the ARP request packet is discarded by that host's ARP module. If a router or bridge is responsible for the IP range within the ARP request, it will respond with its hardware address. If no device responds to the request, then the IP address to be resolved is not reachable.

If, on the other hand, the host having the target IP address to be resolved hears the ARP request then its ARP module will respond by sending an ARP reply packet with the target's Ethernet MAC address. The ARP module on the target host will also update its ARP cache to map the source IP address of the sender with the source's Ethernet MAC address that was transmitted in the ARP request. If the entry is already present in the cache, it is overwritten; otherwise, it is added.

There are various other ARP-related protocols. These include the Reverse APR (RARP) which is defined at RFC 903 for host machines that don't know their IP addresses, and the Inverse ARP (InARP) which defined at RFC 2390 for Frame Relay, to name a few. The general structure for messages within these ARP-related protocols has the following format:

| 0 bit | 16 bit | 32 bit |
|---|---|---|
| Hardware Address Space | | Protocol Address Space |
| Hardware Address | Protocol Address | Operation |
| Length (Bytes) | Length (Bytes) | |

Sender's Hardware Address
Sender's Protocol Address
Target Hardware Address
Target Protocol Address

Attendant with the incredible capabilities afforded by today's global economy is the need to adequately secure data, particularly along computer networks which transmit sensitive information such as credit card data, social security numbers, private correspondences, financial information, to illustrate a few. Although network security is undoubtedly a concern for unsecured networks, such as the internet, security is of equal importance to those operating in other network environments, such as Intranets, Extranets, virtual private networks (VPNs), or any other type of network environment where privacy and authenticity is of interest.

Modern security practices implement layers of physical, administrative, electronic and cryptographic systems to protect valuable resources against known or unknown vulnerabilities. Cryptographic systems, in particular, are widely used to ensure privacy and authenticity of data communicated over insecure channels. Encryption is widely employed to alter data from a plaintext form to a ciphertext form so that it is essentially meaningless to anyone other than the intended recipient. Modern crypto systems use keys in concert with complex mathematical algorithms to encrypt and decrypt messages in manners which are computationally infeasible to circumvent. A highly regarded resource in this field is Bruce Schneier, “Applied Cryptography: Protocols, Algorithms, and Source Code in C”, Wiley Publishing, 2^{nd} ed. 1995.

Two prevalent types of encryption systems exist—secret key cryptography (also referred to as symmetric encryption) and public key cryptography (also referred to as asymmetric encryption). As well documented, with symmetric encryption each participant has a symmetric key that is used in conjunction with symmetric algorithms to encrypt and decrypt data transmissions. Symmetric key encryption thus requires that each party to the communication be privy to the symmetric key in order to encode and decode the information. In public key cryptography, on the other hand, each participant has an associated public key that is available to others, and 1 private key that is not revealed to others.

Implementations of cryptographic systems can be quite effective at transforming an application layer's plain text data into a ciphertext format which is extremely difficult or infeasible for an unauthorized party (i.e., an eavesdropper) to recreate without access to the cipher key(s). Existing cryptographic implementations, while quite robust, can nonetheless be somewhat inconvenient and lack versatility because the encryption often occurs at higher layers within the network protocol stack and traditionally entails involvement by both the application program and the user. This is the situation, for example with Pretty Good Privacy® (PGP), Secure Sockets Layer (SSL) and Secure Shell (SSH) to name a few. Thus, since encryption occurs at these higher layers, the application itself needs to support encryption.

Accordingly, a need remains to provide a new approach for accommodating the ability to encrypt/decrypt data transmissions irrespective of the particular application involved. A more particular need remains to securely exchange a session key between hosts on a network segment such that the session key may then be used as a symmetric key to both encrypt and decrypt packet transmissions between the hosts. It has been found the widely used address resolution protocol offers an attractive environment for accomplishing this.

### BRIEF SUMMARY OF THE INVENTION

Methods are provided relating to the exchange of a cipher key between devices (or hosts) on a network segment to enable encrypted transmissions between the devices. In preferred embodiments the cipher key is a random key which is commonly used by the devices for synchronous encryption/decryption of data. According to a first exemplary embodiment of the method, an address resolution request packet is broadcasted from a first host on the network segment to all other hosts on the segment. The request packet includes a target Internet Protocol (IP) address to be resolved and a first key associated with the first host. A reply packet is transmitted from a second host on the network segment to the first host, and this reply packet includes a hardware address for the second host which corresponds to the target IP address, as well as a session key which has been encrypted using the first key.

In a preferred implementation of the method, a first network communications device on an Ethernet network segment generates an address resolution request packet for resolving a target IP address into an associated Ethernet MAC address, wherein the request packet includes a public key associated with the first network communications device. This public key is preferably part of a public/private key pair. The request packet is broadcast to all hosts on the network segment, and a second network communications device which is identified by the associated Ethernet MAC address receives the request packet. A random session key is preferably generated at the second device and encrypted using the public key associated with the first device, thereby to generate a public key-encrypted session key. Also at the second device, an address resolution reply packet is preferably generated which includes the associated Ethernet MAC address and the public key-encrypted session key, and this reply packet is transmitted from the first device to the second device. Upon receipt of the reply packet at the first device, the encrypted session key is decrypted using the public, whereupon it is revealed.

In each of the above methodologies, it is preferred that the first key/public key be transmitted within the sender hardware address field that is associated with the request packet's structure, and that the encrypted session key be transmitted within the sender hardware address field associated with the reply packet's structure. Advantageously, the hardware type fields for the request and reply packets are populated with associated data corresponding to a type value different than 1 so that these packets may be distinguished from packets which adhere to an Ethernet implementation of the ARP protocol. The hardware address length field for the packets is also populated with associated data corresponding to a length value greater than 6 bytes as a result of the accompanying keys which are transmitted within these packets.

According to another exemplary embodiment of the invention, the session key which has been exchanged is used to encrypt and decrypt subsequent packet transmissions between the first and second devices which correspond to the active session between them. Here, the first device has an associated sender Ethernet MAC address and the second device has an associated target Ethernet MAC address. Preferably, the sender's MAC address is stored within an associated target address resolution protocol (ARP) cache on the second device, while the target MAC address is stored within an associated sender ARP cache on the first device. The session key is used to encrypt and decrypt the subsequent packet transmissions between the devices while these MAC addresses remain in their respective ARP caches.

### BRIEF DESCRIPTION OF THE DRAWINGS

FIG. 1 is a diagrammatic view representing both logical and physical packet transmissions between hosts on different network segments;

FIG. 2 diagrammatically illustrates the dual capability of a host to transmit both normal ARP requests for non-secure communications, as well as modified ARP requests allowing for secure communications over non-secure channels;

FIG. 3 illustrates how a common symmetric key can be used by two hosts to encrypt/decrypt communications between them;

FIG. 4 represents a high level flowchart for an exemplary embodiment of a methodology according to the present invention;

FIGS. 5a and 5b are each timing sequence diagrams which, respectively, illustrate a typical MAC address exchange between a sending and target host, and a modified implementation according to the invention which additionally incorporates a key exchange;

FIG. 6 diagrammatically represents the format for both the request and reply packets according the enhanced address resolution protocol of the invention;

FIG. 7 shows a modified MAC address construct for use with the present invention; and

FIG. 8 illustrates the high level operations which take place when a host equipped with the capabilities of the present invention receives incoming packets.

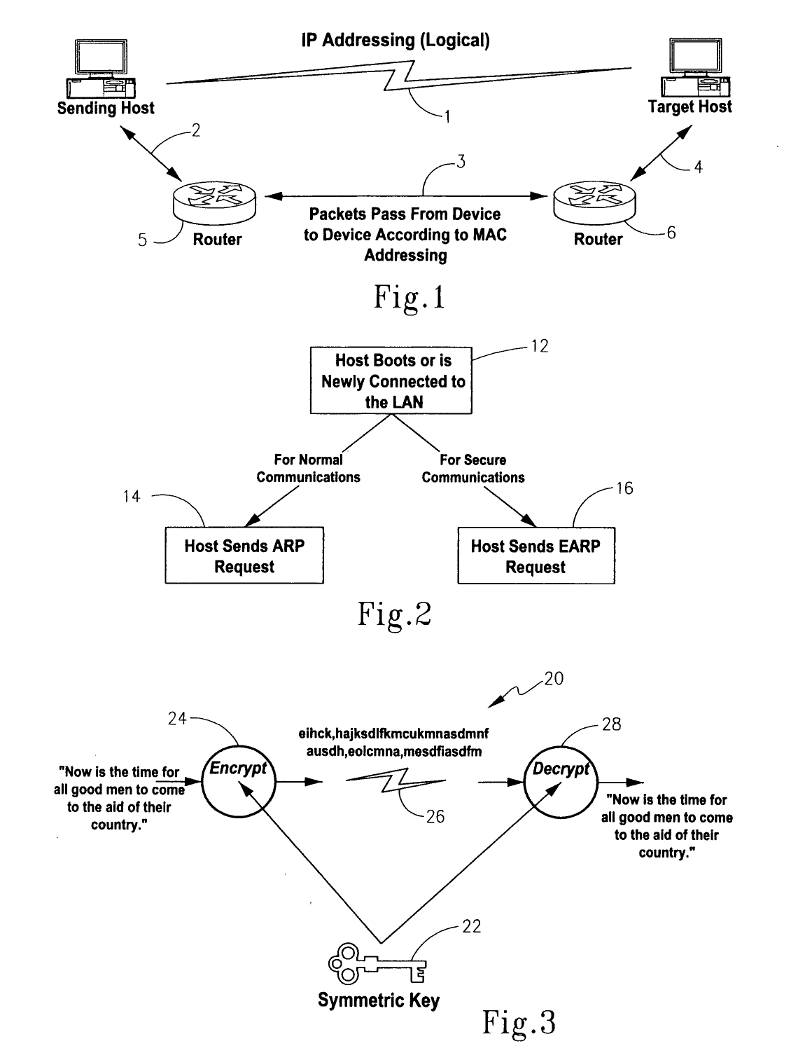

### DETAILED DESCRIPTION OF THE INVENTION

The present invention relates to an approach for exchanging a cipher key, preferably a symmetric session key, between hosts on a network segment. This is accomplished in a matter which is non-disruptive to existing Ethernet implementations and ARP in particular. The ability to exchange the key at a lower level protocol in the network protocol stack enables the key to then be used to encrypt subsequent IP irrespective of the particular application responsible for the traffic. The invention, thus, provides an approach which is essentially transparent to the user and his/her application because, once the key has been exchanged, encryption between the two hosts becomes virtually seamless.

The invention is particularly suited to allow encrypted communications between hosts on the same Ethernet network segment (i.e. a broadcast domain), while still allowing normal message transmissions in accordance with existing ARP protocols. To this end, the invention provides another protocol, referred to for distinction purposes herein as an enhanced address resolution protocol (EARP) which employs the same packet structure as a ARP, but modifies data values within certain fields to accommodate a low level key exchange for encryption/decryption purposes.

With initial reference is made to FIG. 2, when a host additionally equipped with EARP capabilities is brought up on a LAN at 12, both normal ARP requests and EARP requests are broadcasted by the host at 14 and 16, respectively. Normal ARP requests are accommodated to permit communications between both hosts on both the same and different broadcast domains. In the case of hosts on different domains, the ARP request may be routed from device to device according to known MAC addressing protocols, as well known in the art and illustrated above in the background.

The EARP request is generated to optionally allow for secure communications between hosts on the same segment. If another host on the network segment is also equipped with the EARP capabilities, it may respond to the EARP request so that the two devices can exchange a session key needed for their secure communications as part of a symmetric key encryption/decryption scheme. The EARP capability, thus, allows for the secure key exchange between two hosts or devices over a non-secure channel.

As illustrated in diagram 20 of FIG. 3, the symmetric cipher key 22 is used by a sending host at 24 to encrypt plaintext data from an application, thereby generating ciphertext data. The ciphertext is transmitted over the non-secure channel 26 to the target host where it is decrypted at 28 utilizing the same symmetric key 22 previously exchanged between the systems. Encrypted data can also be transmitted in the reverse direction for decryption by the sender using a similar approach.

For security reasons, the symmetric key should not be passed between the sending host and the target without appropriate safeguards in place, since it would be susceptible to a man-in-the-middle attack, for example. That is, if an eavesdropper were able to “sniff” the communication channel between the sender and the target, then the key could be easily detected and further communications exploited. Thus, it is desirable to transmit the key between the sender and the target host surreptitiously. Know cryptographic schemes often do this by encrypting the symmetric key using asymmetric algorithms which employ public/private key pairs. The present invention adopts a similar approach, but instead does so in the environment of a lower level protocol to provide enhancements over these known implementations.

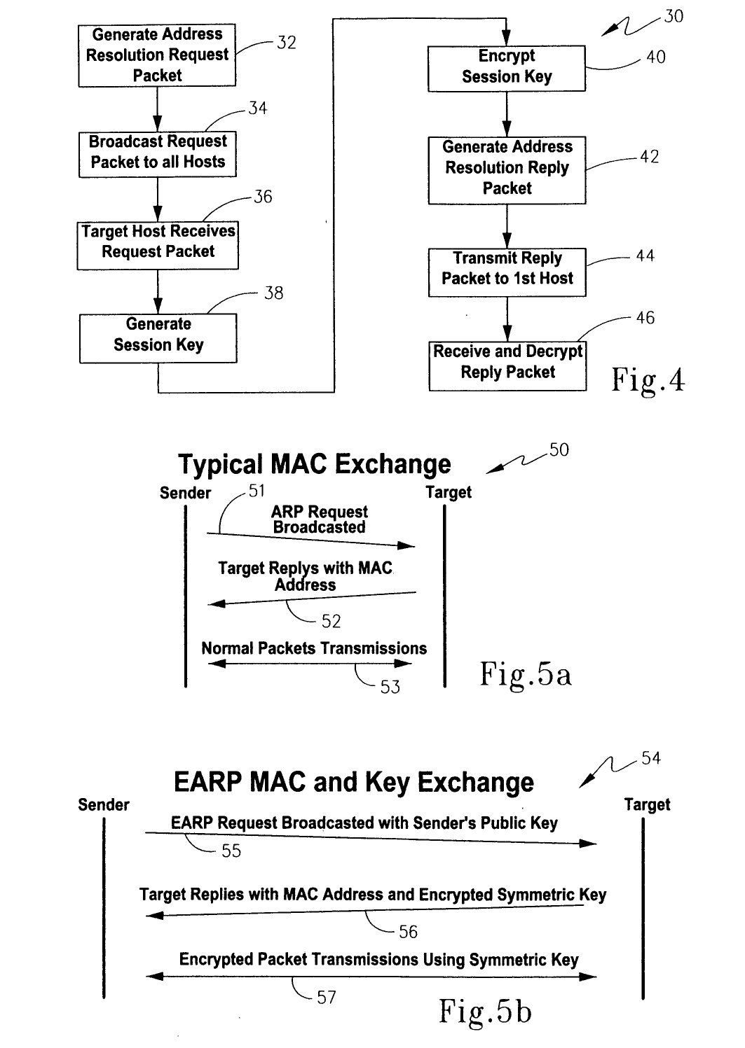

In this regard, a preferred implementation for exchanging a cipher key between the hosts is shown in the flowchart 30 of FIG. 4. Broadly, method 30 entails the broadcasting of an address resolution request packet (in accordance with the EARP) from a first host to all other hosts on the network segment, and the subsequent transmission of a reply packet (also in accordance with the EARP) from a second host which is the target of the request. More particularly, a first host (or first network communications device) on the network segment that is identified by an associated Ethernet MAC address has a key pair including associated public and private keys. Public and private key pairs are well known and there are currently several manners of obtaining them such as through application programs (e.g., PGP) or a suitable certification authority (CA). Thus, a description of how the host(s) obtains the key pair is unnecessary. It is simply being preferred that at least each sending host, and more preferably all hosts, on the network segment have a key pair.

Method 30 contemplates a situation where a first sending host desires communication with another host on the network segment whose IP address is known, but whose hardware address is unknown. Thus, the sending host generates at 32 an address resolution request packet for resolving the target IP address into an associated Ethernet MAC address. The address resolution request packet that is generated includes the sending host's Ethernet MAC address. In this regard, step 32 is akin to the normal ARP. However, to initiate the ability of the hosts to securely exchange the session key, the address resolution request packet at 32 preferably also includes the first host's public key. At 34, this request packet is broadcasted to all hosts on the network segment.

A second host on the network segment which is identified by the target Ethernet MAC address receives the packet at 36 and generates a session key at 38, preferably a random session key which is suitably strong. Random key generation is also well understood in the art and representative ways to obtain one is through a random number generator (RNG), such as a computer chip which takes input from an entropic event, or though a pseudo-random number generator (PRNG) which utilizes a mathematical algorithm.

Once the session key is generated, it is encrypted at 40, preferably also on the target host, utilizing the sending host's public key that was transmitted within the earlier request packet. Thus, a public key-encrypted session key is generated. At 42 the target host generates an address resolution reply packet (also in accordance with the EARP) which includes the target host's Ethernet MAC address and the public key-encrypted session key. This reply packet is transmitted at 44 to the first host. There is no need to broadcast this message since, now, the first host's Ethernet MAC address is known. At 46 the reply packet is received at the first host, whereupon the public key-encrypted session key is decrypted with the first host's private key, thereby revealing the session key in plaintext form on the first host system.

At this point, the session key is available for use as a symmetric key which can be used with a suitable symmetric algorithm such as DES, 3DES, IDEA and AES, Twofish, or Blowfish, to name a few, to encrypt and decrypt subsequent communications between the hosts. The ordinarily skilled artisan will recognize that a variety of available encryption algorithms (both symmetric and asymmetric, or a combination of both asymmetric and symmetric) can be used for the generation and/or protection of the session key for purposes of its exchange, as well as the subsequent encryption/decryption of the communications during a session. For example, RSA available from RSA Data Security is perhaps the only algorithm in widespread use for both public/private key generation and encryption. Thus, the present invention contemplates any approach which one may choose to adopt the effectuate the purposes described or inherent herein, without limitation.

Timing sequence diagrams are now described in FIGS. 5a and 5b to illustrate the differences between a typical MAC address exchange (FIG. 5a) and the combined MAC address and key exchange of the present invention (FIG. 5b). In the timing sequence diagram 50 of FIG. 5a, the sender broadcasts a normal ARP request at 51 which is received by the target, which replies at 52 with its MAC address. Thereafter, packets can be transmitted between the sender and target at 53, all as is known in the art.

In timing sequence diagram 54 in FIG. 5b, however, a modified address resolution protocol (EARP) request is initially broadcasted at 55 and includes the sender's public key. Once received by the target host, it replies at 56 with its MAC address and includes the public key-encrypted session key (i.e. the encrypted symmetric key) which only the sender can decode. Thereafter, at 57, the two devices can transmit packets back and fourth in encrypted form utilizing the synchronous key.

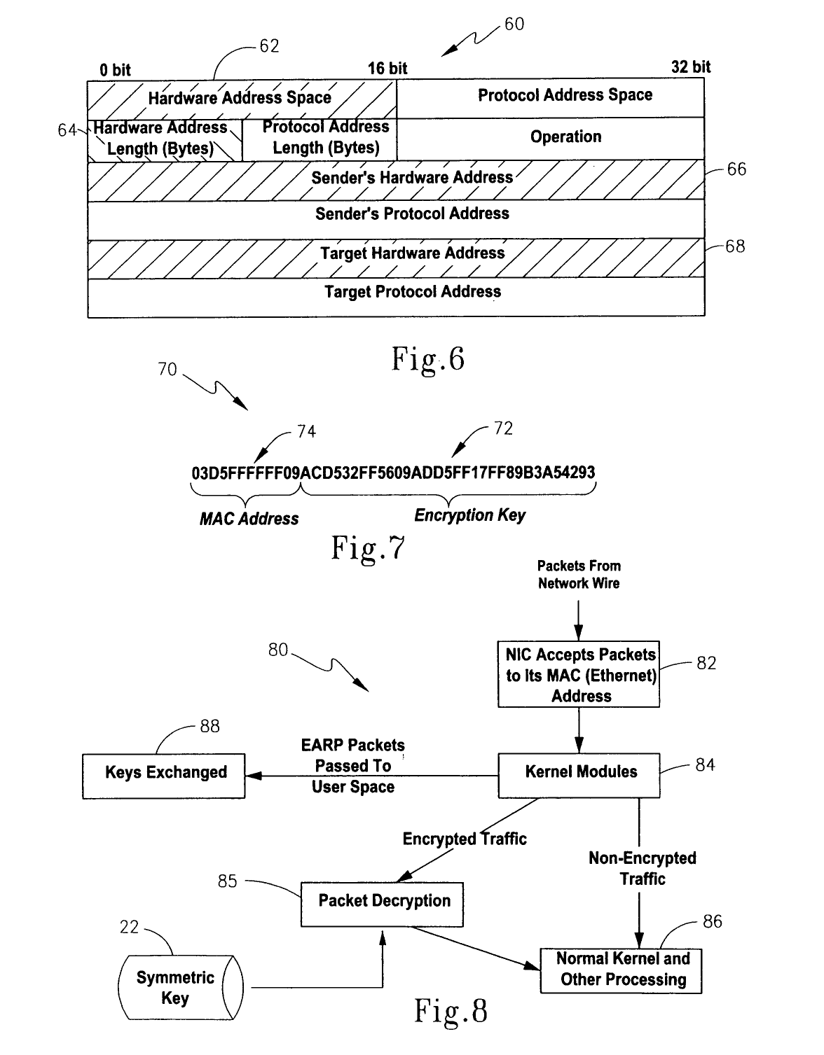

The format of both the request and reply packets according the EARP are the same and adhere to the format of an ARP message as defined in the ARP protocol. This format is diagrammatically illustrated in FIG. 6. During implementation of the invention, however, various fields within the structure for the request and reply packets are affected to incorporate data which is different than that which populates these fields during normal ARP message transmissions. These modified fields are distinguished in FIG. 6 by crosshatching.

For purposes of explanation, Table 1 below is also provided to further describe some of the notable differences between field data values for typical MAC hardware addressing according to the ARP and the modified addressing, coupled with key exchange, according to the EARP of the present invention. Also for comparison purposes, Table 1 highlights differences in the various field values between the ARP and RARP.

TABLE 1

| | | Typical MAC Hardware | |
|---|---|---|---|
| | Item | Addressing | EARP Addressing |
| 16 bit | Hardware | The type of hardware address | New type value (e.g. FF) which does not to |
| | Address Space | present in the packet (e.g., | conflict with other hardware types. |
| | | Ethernet, Packet Radio Net) | |
| 16 bit | Protocol | The type of the protocol address | SAME |
| | Address Space | requested for the hardware | |
| | | address. 0x800 in the case of IP | |
| | | addressing. | |
| 8 bit | Length of | The size (N bytes from below) of | The value of this field is 22 (6 + 16) for 128- |
| | Hardware | the hardware address. For | bit keys |
| | Address | Ethernet, the value of this field is | |
| | | 6. | |
| 8 bit | Length of | The size (M bytes from below) | SAME |
| | Protocol | of the protocol address. For IP, | |
| | Address | the value of this field is 4. | |
| 16 bit | Operation Code | The type of operation being | SAME |
| | | performed. The value of this | |
| | | field can be 3 (RARP request) or | |
| | | 4 (RARP reply). | |
| N bytes | Source | Hardware address of sender of | EARP Request: hardware MAC address of |
| | Hardware | the packet. | sender plus sender's public key |
| | Address | ARP Request: hardware MAC | EARP Reply: hardware MAC address of |
| | | address of sender | target plus public-key encrypted session key |
| | | ARP Reply: hardware MAC | |
| | | address of target | |
| | | RARP Request: hardware MAC | |
| | | address of sender | |
| | | RARP Reply: hardware MAC | |
| | | address of target | |
| M bytes | Source Protocol | Protocol address of sender of | SAME |
| | Address | this packet | |
| | | ARP Request: IP address of | |
| | | sender | |
| | | ARP Reply: IP address of | |
| | | target | |
| | | RARP Request: undefined | |
| | | RARP Reply: IP address of | |
| | | target | |
| N bytes | Target | Hardware address of target of | EARP Request: unknown |
| | Hardware | this packet | EARP Reply: hardware MAC address of |
| | Address | ARP Request: unknown | sender plus, optionally, sender's public key |
| | | ARP Reply: hardware MAC | |
| | | address of sender | |
| | | RARP Request: hardware MAC | |
| | | address of target | |
| | | RARP Reply: hardware MAC | |
| | | address of sender | |
| M bytes | Target Protocol | Protocol address of target of | SAME |
| | Address | this packet | |
| | | ARP Request: IP address of | |
| | | target | |
| | | ARP Reply: IP address of sender | |
| | | RARP Request: undefined | |
| | | RARP Reply: IP address of | |
| | | sender | |

With reference then to FIG. 6 and Table 1, it can be seen that the hardware address space field 62 within the MARP packet 60 is populated with a data value that does not conflict with other hardware types used in normal ARP messaging. For example, typical Ethernet often has a value of 1 within the hardware type field of an ARP packet. As such, in the present implementation, it is preferred to have a type value different than 1 (such as FF) so that the MARP packet is distinguished from an ARP packet. The hardware address length field 64 reflects the size (in bytes) of the hardware address which populates, for example, the hardware address field 66. With IPv4 over Ethernet, this field normally has a value of 6 bytes.

However, in the present invention the sender hardware address field 66 (in the case of a request packet from a sending host) preferably also includes the sending host's public key in addition to its hardware MAC address. For a 128-bit public key (i.e. 16 bytes), as an example, this translates into a length value of 22 bytes within field 64. If it is presumed that the sending host's ARP cache does not have a mapping for the target host's MAC address, then in an initial request packet the target hardware address field 68 will be empty. Otherwise, it could be populated with the target host's MAC address since that would be known once the reply packet is received and the sending host's ARP cache is updated accordingly.

Once the target host generates the address resolution reply packet, it preferably places the public key-encrypted session key, along with its target Ethernet MAC address, within the source hardware address field 66 of the reply packet. The target hardware address field 68 of the reply packet would, here, include the sending host's MAC address (since it is now known) and, optionally, the sending host's public key that was previously transmitted. Once the encrypted session key has been exchanged, all remaining IP traffic to and from the selected hosts which correspond at least to the active session between them can be encrypted and decrypted using this symmetric key.

It can be appreciated then that inclusion within a packet's hardware address field of a key (whether the public key from the sender or the encrypted session key from the target) along with a MAC address can be regarded as a different addressing approach than that offered by the ARP-related protocols. FIG. 7 illustrates the difference. Here it can be seen that a modified construct 70 is defined which includes an encryption key 72, such as a 128-bit key, which is appended to the Ethernet MAC address portion 74.

The existing ARP-related protocols accommodate the ability to modify these various field values as described above so that artisan will recognize that the EARP of the present invention can be conveniently designed in a manner which borrows from these existing and well understood protocol constructs. Furthermore, the artisan sufficiently familiar with operating system architectures will also realize that implementing the capabilities of the present invention into an existing host system might require re-writing the driver for the NIC in order to, among other things, modify it to recognize and extract the session key when is transmitted within a reply packet. The network stack might also need to be tailored to insert the encryption and decryption capabilities into its processing portion. It is preferred to do this in a manner which does not encrypt the MAC address, but rather accomplishes encryption at layer 2 between the Ethernet frame and the IP datagram. Designing a system in light of these considerations would be within the purview, for instance in a Linux OS environment, of one having sufficient familiarity with the C programming language, assembly language, and kernel and driver designs.

Final reference is now made to FIG. 8 to illustrate at a high level the operations 80 which take place at a host along an Ethernet network segment (which is equipped with the EARP capabilities described herein) when it receives incoming packets. At 82, the host's NIC accepts incoming packets to its Ethernet MAC address. The NIC driver then passes the packets at 84 to the kernel for processing. Depending on the type of packet received it may be passed to a suitable module within the kernel for processing. Thus, for example, if the received packet is not encrypted then it is passed at 86 for normal kernel and other processing. If the received packet is encrypted, it is passed to a decryption engine at 85 which utilizes the symmetric key 22 that was previously exchanged, whereupon the packet is decrypted and then passed for normal kernel processing at 86. Otherwise, if the incoming packet is from another host on the network segment which has issued a broadcast including its public key, as described above, then the incoming packet is sent at 88 to one or more suitable processing modules for generating the random session key, encrypting it and transmitting within a reply packet back to the requestor.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A method of exchanging a cipher key between hosts on a network segment, comprising:
a. broadcasting an address resolution request packet from a first host on the network segment to all other hosts on the network segment, wherein said request packet includes a target Internet Protocol (IP) address to be resolved and a first key associated with the first host; and
b. transmitting a reply packet from a second host on the network segment to the first host, said reply packet including a hardware address for the second host that is correlated to the target IP address, and a session key which has been encrypted using said first key.

2. A method according to claim 1 whereby said first key is a public key associated with the first host.

3. A method according to claim 1 whereby said network segment is an Ethernet segment and said hardware address is an Ethernet MAC address.

4. A method according to claim 1 whereby said request packet has an associated request packet structure, and whereby said first key is transmitted within a sender hardware address field of said request packet structure.

5. A method according to claim 1 whereby said reply packet has an associated reply packet structure, and whereby said session key is transmitted within a sender hardware address field of said reply packet structure.

6. A method according to claim 4 whereby said hardware type field is populated with associated data corresponding to a type value different than 1.

7. A method according to claim 5 whereby said hardware type field is populated with associated data corresponding to a type value different than 1.

8. A method according to claim 4 whereby said hardware address length field is populated with associated data corresponding length value greater than 6 bytes.

9. A method according to claim 5 whereby said hardware address length field is populated with associated data corresponding length value greater than 6 bytes.

10. A method of securely exchanging a cipher key to be used for encrypted packet transmissions between devices on an Ethernet network segment, comprising:
a. generating, at a first network communications device on the network segment, an address resolution request packet for resolving a target Internet Protocol (IP) address into an associated Ethernet MAC address, wherein said address resolution request packet includes a public key associated with the first network communications device;
b. broadcasting said request packet to all hosts on the network segment;
c. receiving the request packet at a second network communications device on the network segment which is identified by the associated Ethernet MAC address;
d. generating a random session key;
e. encrypting said session key using the public key associated with the first network communications device, thereby to generate a public key-encrypted session key;
f. generating an address resolution reply packet which includes the associated Ethernet MAC address and said public key-encrypted session key; and
g. transmitting said reply packet from the second network communications device to the first network communications device;
h. receiving said reply packet at the first network communications device; and
i. decrypting public key-encrypted session key with a private key associated with the first network communications device, thereby revealing said session key to the first network communications device.

11. A method of securely exchanging a cipher key according to claim 10 whereby said random session key is generated at the second network communications device.

12. A method of securely exchanging a cipher key according to claim 10 whereby said session key is encrypted at the second network communications device.

13. A method of securely exchanging a cipher key according to claim 10 whereby said request packet has an associated request packet structure, and whereby said public key is transmitted within a sender hardware address field of said request packet structure.

14. A method of securely exchanging a cipher key according to claim 10 whereby said address resolution reply packet is generated at the first network communications device and has an associated reply packet structure, and whereby said public key-encrypted session key is transmitted within a sender hardware address field of said reply packet structure.

15. A method according to claim 13 whereby said hardware type field is populated with associated data corresponding to a type value different than 1.

16. A method according to claim 14 whereby said hardware address length field is populated with associated data corresponding length value greater than 6 bytes.

17. A method according to claim 13 whereby said hardware address length field is populated with associated data corresponding length value greater than 6 bytes.

18. A method according to claim 14 whereby said hardware address length field is populated with associated data corresponding length value greater than 6 bytes.

19. A method of accommodating encrypted packet transmissions between devices on an Ethernet network segment through secure exchange of a synchronous cipher key, comprising:
a. at a first network communications device on the network segment having an associated public key, an associated private key and an associated sender Ethernet MAC address:
i. generating an address resolution request packet for purpose of resolving a target IP address into a corresponding target Ethernet MAC address, wherein said request packet includes said public key and said sender Ethernet MAC address; and
ii. broadcasting said request packet to all hosts on the network segment;
b. at a second network communications device on the network segment which is identified by the target Ethernet MAC address:
i. generating a random session key;
ii. encrypting said session key into an encrypted session key by using said public key;
iii. generating an address resolution reply packet which includes the target Ethernet MAC address and said encrypted session key; and
iv. transmitting said reply packet to the first network communications device; and
c. decrypting said encrypted session at the first network communications device by using said private key; and
d. using said session key to encrypt and decrypt subsequent packet transmissions between the first and second network communications devices which correspond to an active session between them.

20. A method according to claim 19 comprising storing the sender Ethernet MAC address within an associated target address resolution protocol (ARP) cache on the second network communications device, and storing the target Ethernet MAC address within an associated sender address resolution protocol (ARP) cache on the first network communications device.

21. A method according to claim 20 comprising using said session key to encrypt and decrypt said subsequent packet transmissions between the first and second network communications while the sender and target Ethernet MAC addresses remain within the target and sender ARP caches, respectively.

22. A method according to claim 21 whereby (a) and (b) thereof are repeated with respect to at least one subsequent session between the first and second network communications devices.
